(19) United States
(12) Patent Application Publication
(10) Pub. No.: US 2014/0356055 A1
(43) Pub. Date: Dec. 4, 2014

(54) JOINING METHOD, JOINT STRUCTURE AND METHOD FOR PRODUCING THE SAME

(71) Applicant: MURATA MANUFACTURING CO., LTD., Nagaokakyo-shi (JP)

(72) Inventors: Kosuke Nakano, Nagaokakyo-shi (JP); Yasuyuki Seikmoto, Nagaokakyo-shi (JP); Hidekiyo Takaoka, Nagaokakyo-shi (JP); Daisuke Tsuruga, Nagaokakyo-shi (JP)

(21) Appl. No.: 14/459,383

(22) Filed: Aug. 14, 2014

Related U.S. Application Data
(63) Continuation of application No. PCT/JP2013/052556, filed on Feb. 5, 2013.

(30) Foreign Application Priority Data
Mar. 5, 2012 (JP) 2012-048022

(51) Int. Cl. B23K 20/00

(52) U.S. Cl. CPC B23K 20/00
USPC 403/271; 228/196

(57) ABSTRACT

When a first joining object and a second joining object are joined to each other, the first joining object has a first metal composed of Sn or an alloy containing Sn, the second joining object has a second metal composed of an alloy containing at least one selected from among Ni, Mn, Al and Cr, and Cu. The first joining object and the second joining object are subjected to heat treatment in a state of being in contact with each other to produce an intermetallic compound at an interface between both joining objects such that both joining object are joined to each other. An alloy containing Sn in an amount of 70% by weight or more is used as the first metal. An alloy containing Sn in an amount of 85% by weight or more is used as the first metal.

### CROSS REFERENCE TO RELATED APPLICATIONS

The present application is a continuation of International application No. PCT/JP2013/052556, filed Feb. 5, 2013, which claims priority to Japanese Patent Application No. 2012-048022, filed Mar. 5, 2012, the entire contents of each of which are incorporated herein by reference.

### FIELD OF THE INVENTION

The present invention relates to a method of joining one joining object (first joining object) and the other joining object (second joining object) to each other, a joint structure formed by using the joining method, and a method for producing the joint structure.

### BACKGROUND OF THE INVENTION

As a mounting method in mounting a surface-mounted electronic part on a substrate or the like, a method of mounting an electronic part by soldering an external electrode of the electronic part to an electrode for mounting (land electrode) on the substrate is widely used.

As a solder paste used for such mounting by soldering, for example, a solder paste including a mixture of (a) a second metal (or alloy) ball made of a high melting point metal such as Cu, Al, Au, or Ag or a high melting point alloy containing the high melting point metal, and (b) a first metal ball made of Sn or In is proposed (Patent Document 1).

Further, in Patent Document 1, a joining method using the solder paste, and a method for manufacturing an electronic equipment are disclosed.

By the way, when soldering is performed by using the solder paste described in Patent Document 1, as schematically shown in FIG. 8(a), the solder paste including low melting point metal (e.g., Sn) balls 51, high melting point metal (e.g., Cu) balls 52 and a flux 53 is heated to react, and after soldering, as shown in FIG. 8(b), a plurality of high melting point metal balls 52 are connected to one another with an intermetallic compound 54 formed between a low melting point metal originating from the low melting point metal ball and a high melting point metal originating from the high melting point metal ball interposed therebetween, and by this connecting body, joining objects are connected (soldered) to each other.

However, in the joining method and the method for manufacturing an electronic equipment described in Patent Document 1, there is a problem that facilities and steps for performing the joining method are limited since it is necessary to prepare a solder paste separately in order to connect joining objects to each other.

Further, in the case of the solder paste described in Patent Document 1, the intermetallic compound between the high melting point metal (e.g., Cu) and the low melting point metal (e.g., Sn) is produced by heating the solder paste in the soldering step, and in the combination of Cu (high melting point metal) and Sn (low melting point metal), Sn being a low melting point metal remains because the diffusion rates of these metals are slow. In the case of a solder paste in which Sn remains, the joint strength under elevated temperatures is significantly deteriorated, and there may be cases where a product cannot be used depending on the type of the product to be joined. Further, there is a possibility that Sn remaining after the step of soldering may be melted and flowed out in the subsequent another soldering step, and there is a problem that this soldering is low in reliability as high temperature solder which is used for a bonding method with temperature hierarchy.

That is, for example, in a manufacturing process of a semiconductor device, when a semiconductor device is manufactured after undergoing a step of soldering, and then the semiconductor device is to be mounted on a substrate by a reflow soldering method, there is a possibility that Sn remaining after the step of soldering in the manufacturing process of a semiconductor device is melted and flowed out in the step of reflow soldering.

Further, it is necessary to heat the solder paste at a high temperature for a long time in the soldering step in order to convert the low melting point metal entirely to the intermetallic compound so that Sn may not remain, but this heating is practically impossible in consideration of the balance with productivity.

In order to solve the above-mentioned problems, there is proposed a solder paste including a metal component containing a first metal powder and a second metal powder having a higher melting point than the first metal powder, and a flux component, wherein the first metal is Sn or an alloy containing Sn, and the second metal (Cu—Mn or Cu—Ni) is a metal or an alloy which forms, with the first metal, an intermetallic compound exhibiting a melting point of 310° C. or higher, and has a lattice constant difference of 50% or more, the lattice constant difference being a difference between the lattice constant of the intermetallic compound produced first around the second metal powder and the lattice constant of the second metal component (Patent Document 2).

In addition, Patent Document 2 mentions a conductor pattern or Cu—Ni as the second metal.

Further, Patent Document 2 proposes a joining method and a joint structure that use the above-mentioned solder paste, and a method for manufacturing an electronic equipment.

It is described that in accordance with the joining method using the solder paste, joining by which the amount of remaining Sn is largely reduced to avoid the flow out of solder at the time of reflowing, and which is excellent in the joint strength and joint reliability at a high temperature can be performed.

However, in the case of the joining method using the solder paste of Patent Document 2, since a diffusion reaction of the second metal such as Cu—Mn or Cu—Ni with the first metal such as Sn or a Sn alloy rapidly occurs, the time during which Sn exhibits a liquid state is short and an intermetallic compound having a high melting temperature is formed soon, and therefore there is a possibility that air gaps are generated within the joint portion. Accordingly, a joining method in which joining having higher joint reliability can be performed is expected.

Also, in the case of the joining method described in Patent Document 2, facilities and steps for performing the joining method are limited since it is necessary to prepare a solder paste separately in addition to joining objects.

Patent Document 1: Japanese Patent Laid-open Publication No. 2002-254194

Patent Document 2: WO 2011/027659 A

### SUMMARY OF THE INVENTION

The present invention was made to solve the above-mentioned problem, and it is an object of the present invention to provide a method of joining a first joining object and a second joining object to each other, enabling to perform, without having to use a joining material such as a solder paste separately, highly reliable joining in which there is no air gap in the joint portion and the joint portion is excellent in heat resistance, a joint structure formed by using the joining method and having high joint reliability, and a method for producing the joint structure.

In order to solve the above-mentioned problem, a joining method of the present invention is

a method of joining a first joining object and a second joining object to each other, and is characterized in that

the first joining object has a first metal composed of Sn or an alloy containing Sn,

a second joining object has a second metal composed of an alloy containing at least one selected from among Ni, Mn, Al and Cr, and Cu, and

the first joining object and the second joining object are subjected to heat treatment in a state of being in contact with each other to produce an intermetallic compound at an interface between both the joining objects, and thereby the first joining object and the second joining object are joined to each other.

In addition, in the present invention, the “first joining object” and the “second joining object” are designations for discriminating one of a pair of joining objects from the other, and the designations are not intended to distinguish one joining object from the other joining object depending on the kind or structure of the joining object.

For example, when an external electrode of a chip type electronic part is joined to an electrode for mounting of a circuit board, the former may be taken as the first joining object and the latter may be taken as the second joining object, or the latter may be taken as the first joining object and the former may be taken as the second joining object.

As the first and second joining objects in the joining method of the present invention, for example, an external electrode of a chip type electronic part and an electrode for mounting on a circuit board on which the chip type electronic part is mounted can be mentioned as described above, and the present invention includes the cases where one of the joining objects is, for example, a “Cu wire formed by plating a first metal or a second metal” or a “metal terminal formed by plating a first metal or a second metal.”

Further, in the present invention, examples of the first metal (low melting point metal having a lower melting point than the second metal) composed of Sn or an alloy containing Sn include metals given in the form of a plating layer formed on the surface of an electrode and composed of Sn or an alloy containing Sn. In this case, the plating layer composed of the first metal (Sn or an alloy containing Sn) is preferably located at the outermost surface of the first joining object or the second joining object. However, it is also possible to further form another layer (e.g., a noble metal layer) on the outermost surface in some cases.

Further, the second joining object has a second metal composed of an alloy (Cu alloy) containing at least one selected from among Ni, Mn, Al and Cr, and Cu, and examples of the second metal also include metals given in the form of a Cu alloy-plating layer formed on the surface of an electrode. The plating layer composed of the second metal is also preferably located at the outermost surface of the first joining object or the second joining object, but an antioxidant film such as a Sn-plating layer or an Au-plating layer may be formed on the outermost surface in some cases.

In the present invention, the first metal is preferably an alloy containing Sn in an amount of 70% by weight or more.

When the first metal is an alloy containing Sn in an amount of 70% by weight or more, it is possible to achieve more reliably the effect of the present invention of enabling to obtain the joint portion which has no air gaps, and is excellent in heat resistance.

In addition, the first metal is more preferably an alloy containing Sn in an amount of 85% by weight or more.

When the first metal is an alloy containing Sn in an amount of 85% by weight or more, it is possible to obtain a joint portion having higher heat resistance more reliably.

In the present invention, the second metal is preferably predominantly composed of a Cu—Ni alloy or a Cu—Mn alloy.

When the second metal is predominantly composed of a Cu—Ni alloy and/or a Cu—Mn alloy, it is possible to obtain a joint portion having particularly high heat resistance.

Further, the Cu—Ni alloy preferably contains Ni in an amount of 5 to 30% by weight and the Cu—Mn alloy preferably contains Mn in an amount of 5 to 30% by weight.

By employing the above-mentioned constitution, a joint portion having particularly high heat resistance can be obtained more reliably.

A joint structure of the present invention is characterized in that it is formed by the above-mentioned joining method of the present invention.

That is, the joint structure of the present invention is a joint structure in which a first joining object and a second joining object are joined to each other, and is characterized in that the first joining object and the second joining object are joined to each other with an intermetallic compound produced by the reaction between the first metal (Sn or an alloy containing Sn) and the second metal (an alloy (Cu alloy) containing at least one selected from among Ni, Mn, Al and Cr, and Cu).

A method for producing a joint structure of the present invention is characterized in that the above-mentioned joining method of the present invention is used in the method.

In the joining method of the present invention, the first joining object has a first metal composed of Sn or an alloy containing Sn, the second joining object has a second metal composed of an alloy (Cu alloy) containing at least one selected from among Ni, Mn, Al and Cr, and Cu, and the first joining object and the second joining object are subjected to heat treatment in a state of being in contact with each other to produce an intermetallic compound of the first metal and the second metal at an interface between both the joining objects, and thereby the first joining object and the second joining object are joined to each other, and therefore it is possible to perform, without having to prepare a joining material such as a solder paste separately, highly reliable joining in which there is no air gap in the joint portion and the joint portion is excellent in heat resistance.

That is, in the present invention, since one of the joining objects has a first metal composed of Sn or an alloy containing Sn, and the other of the joining objects has a second metal composed of an alloy containing at least one selected from among Ni, Mn, Al and Cr, and Cu, rapid diffusion of the second metal (Cu alloy) and the first metal (Sn or a Sn alloy) occurs in the step of heat treatment by subjecting both the joining objects to heat treatment in a state of being in contact with each other, an intermetallic compound having a high melting point is produced in the joint portion, and most of the first metal such as Sn or a Sn alloy turns into an intermetallic compound.

As a result, it is possible to obtain a joint portion having high joint reliability at a high temperature, which does not cause falling off of an electronic part when reflow is carried out multiple times after an electronic part is mounted or when the mounted electronic part (for example, car-mounted electronic part) is used in a high-temperature environment, for example, in the case where the first joining object is an external electrode of the electronic part and the second joining object is an electrode for mounting of a substrate.

When the first joining object and the second joining object is joined to each other by using the joining method of the present invention, the heat treatment is performed without using a solder paste separately in a state in which the first joining object is in contact with the second joining object. In this case, when the temperature reaches the melting point of the first metal (Sn or a Sn alloy) or higher, the first metal in the first joining object is melted. Then, the first metal and the second metal (Cu alloy) in the second joining object are rapidly diffused to produce an intermetallic compound.

When the heating is further continued thereafter, the first metal (Sn or a Sn alloy) further reacts with the second metal (Cu alloy), and when the compositional ratio of the first metal to the second metal is in a preferred condition, all of the first metal turns into an intermetallic compound and the first metal (Sn or a Sn alloy) disappear.

In the present invention, since a lattice constant difference between an intermetallic compound produced at an interface between the first metal and the second metal and the second metal is large (the lattice constant difference between the second metal and the intermetallic compound is 50% or more), the reaction between the first metal and the second metal is repeated while the intermetallic compound is peeled and disappears in the melted first metal, and therefore production of the intermetallic compound outstandingly proceeds and the content of the first metal (Sn or a Sn alloy) can be adequately reduced in a short time. As a result, it is possible to perform joining having high strength in high temperature.

In addition, since all Al and Cr constituting the second metal (Cu alloy) have smaller first ionization energy than Cu and these metals (Al and Cr) are solid-solved in Cu, Al and Cr are oxidized prior to Cu. As a result, diffusion of Cu which is not oxidized into the melted first metal (Sn or a Sn alloy) is promoted, and the second metal forms an intermetallic compound with the first metal in an extremely short time. Accordingly, the content of the first metal in the joint portion is decreased by the amount of the intermetallic compound formed, and thereby, the melting point of the joint portion is raised to improve the strength in high temperature.

Further, in the present invention, when the second metal (the above Cu alloy) of the second joining object is an electrode or a plating layer formed thereon, since the second metal can be supplied in a state of having a small surface area compared with the case where the second metal is a powder, the area of contact with the first metal (Sn or a Sn alloy) of the first joining object can be reduced to decrease the rate of reaction. As a result, it becomes possible to lengthen the duration of time during which Sn or a Sn alloy (first metal) exists in a liquid state to form a joint portion which has no air gaps and is compact.

Further, the present invention can provide a highly reliable joint structure having high strength in high temperature since the first joining object and the second joining object are joined to each other with a joint portion predominantly composed of an intermetallic compound having a high melting point interposed therebetween as described above.

In addition, in order to achieve the effect of the present invention more reliably, it is preferred to set the ratio between the amount of the first metal (Sn or a Sn alloy) of the first joining object and the amount of the second metal (an alloy containing at least one selected from among Ni, Mn, Al and Cr, and Cu) of the second joining object within a predetermined range, and it is generally preferred that the ratio of the amount of the first metal to the total amount of the first metal and the second metal be 70% by volume or less.

### BRIEF EXPLANATION OF THE DRAWINGS

FIG. 1 is a drawing showing a chip type electronic part which is used to carry out the joining method of the present invention and provided with an external electrode being a first (or second) joining object.

FIG. 2 is a drawing showing a glass-epoxy substrate which is used to carry out the joining method of the present invention and provided with an electrode for mounting being a second (or first) joining object.

FIG. 3 is a drawing showing one step in joining the first joining object and the second joining object to each other by a joining method of the present invention.

FIG. 4 is a drawing showing a joint structure formed by joining the first joining object and the second joining object to each other by the joining method of the present invention.

FIG. 5 is a drawing showing a variation example of the joint structure formed by joining the first joining object and the second joining object to each other by the joining method of the present invention.

FIG. 6 is a drawing for explaining another embodiment of the joining method of the present invention, and is a drawing showing a state in which a chip type electronic part, being a first joining object and provided with a bump, is placed on a substrate for mounting being a second joining object and provided with an electrode for mounting.

FIG. 7 is a drawing showing a state after a chip type electronic part is placed on a substrate for mounting as shown in FIG. 6 and heating and pressing is performed.

FIGS. 8(a) and 8(b) are drawings showing a behavior of solder in the case of soldering using a conventional solder paste, wherein FIG. 8(a) is a drawing showing a state before heating and FIG. 8(b) is a drawing showing a state after completion of a soldering step.

### DETAILED DESCRIPTION OF THE INVENTION

Examples of the present invention will be shown below, and characteristics of the present invention will be described in more detail.

### Embodiment 1

In the present embodiment, a case in which an external electrode (first joining object) of a chip type electronic part is joined to an electrode for mounting (second joining object) on a glass-epoxy substrate in mounting the chip type electronic part having the external electrodes disposed at both ends of a ceramic laminate (laminated ceramic capacitor) on the electrode for mounting on the glass-epoxy substrate will be described as an example.

[Preparation of Chip Type Electronic Part and Glass-epoxy Substrate]

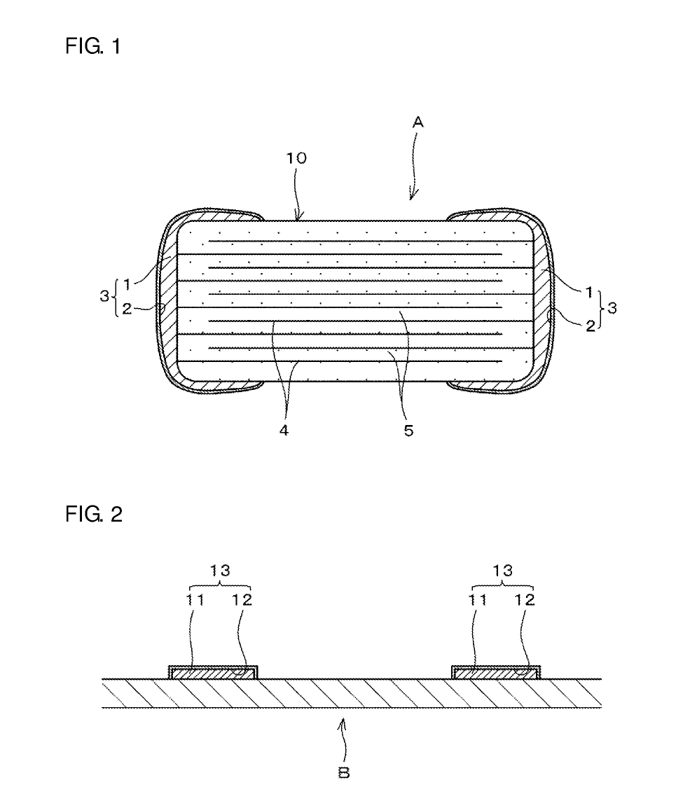

First, prepared was a chip type electronic part A having external electrodes (first joining objects) 3 each provided with a plating layer 2 formed by plating, with Sn or an alloy containing Sn (first metal) as shown in sample Nos. 1 to 25 in Tables 1 and 2, the surface of each of external electrode main bodies 1 which are formed at both ends of a ceramic laminate 10 formed by laminating internal electrodes 4 and ceramic layers 5 alternately and made of a Cu thick-film electrode, as shown in FIG. 1.

In addition, although not shown, Ni-plating was formed between the Cu thick-film electrode and the plating layer 2 of Sn or an alloy containing Sn.

The plating layer 2 does not necessarily have to cover the entire surface of the external electrode main body 1, and the plating layer 2 may be provided for the external electrode main body 1 in such a manner that an intermetallic compound is formed by the reaction with a second metal (a Cu alloy is employed in this embodiment) composing a plating film 12 of an electrode 13 for mounting described below in a heat treatment step.

In addition, as the first metal (low melting point metal) composing the plating layer 2, as shown in Tables 1 and 2, a Sn-3Ag-0.5Cu, Sn, Sn-3.5Ag, Sn-0.75Cu, Sn-15Bi, Sn-0.7Cu-0.05Ni, Sn-5Sb, Sn-2Ag-05Cu-2Bi, Sn-30Bi, Sn-3.5Ag-0.5Bi-81n, Sn-9Zn, or Sn-8Zn-3Bi alloy was used.

In addition, in the above expressions of the first metal, for example, the “Sn-3Ag-0.5Cu” of the sample No. 1 indicates that the low melting point metal material is an alloy (Sn alloy) containing Ag in an amount of 3% by weight, Cu in an amount of 0.5% by weight, and Sn as the rest of the material.

Further, as shown in FIG. 2, prepared was a glass-epoxy substrate B having an electrode for mounting (second joining object) 13 provided with a plating layer 12 which was formed by plating the surface of a Cu electrode film 11 formed on the principal surface of a substrate made of glass-epoxy with an alloy (second metal) containing at least one selected from among Ni, Mn, Al and Cr, and Cu. In addition, the plating layer 12 may be formed so as to cover the entire surface of the Cu electrode film 11, that is, the top face and the side face of the Cu electrode film 11, as shown in FIG. 2, or may be formed only on the top face of the Cu electrode film 11 or only on a part of the top face.

In addition, as the second metal (Cu alloy) composing the plating layer 12, as shown in Tables 1 and 2, a Cu-5Ni, Cu-10Ni, Cu-15Ni, Cu-20Ni, Cu-30Ni, Cu-5Mn, Cu-10Mn, Cu-15Mn, Cu-20Mn, Cu-30Mn, Cu-12Mn-4Ni, Cu-10Mn-1P, Cu-10Al or Cu-10Cr alloy was used.

The second joining object (the electrode for mounting of the glass-epoxy substrate) may contain Mn and Ni simultaneously as with the sample No. 22, or may contain a third component such as P (phosphorus) as with the sample No. 23.

Further, for comparison, the samples of sample Nos. 26 and 27 in Table 2, not complying with the requirements of the present invention, were prepared as the second joining object.

In addition, the second joining object (an electrode for mounting of a glass-epoxy substrate) of the sample No. 26 is one formed by providing a plating layer made of Cu for the surface of a Cu electrode film, and the second joining object (an electrode for mounting of a glass-epoxy substrate) of the sample No. 27 is one formed by providing a plating layer made of a Cu—Zn alloy for the surface of a Cu electrode film.

[Joining of First Joining Object to Second Joining Object]

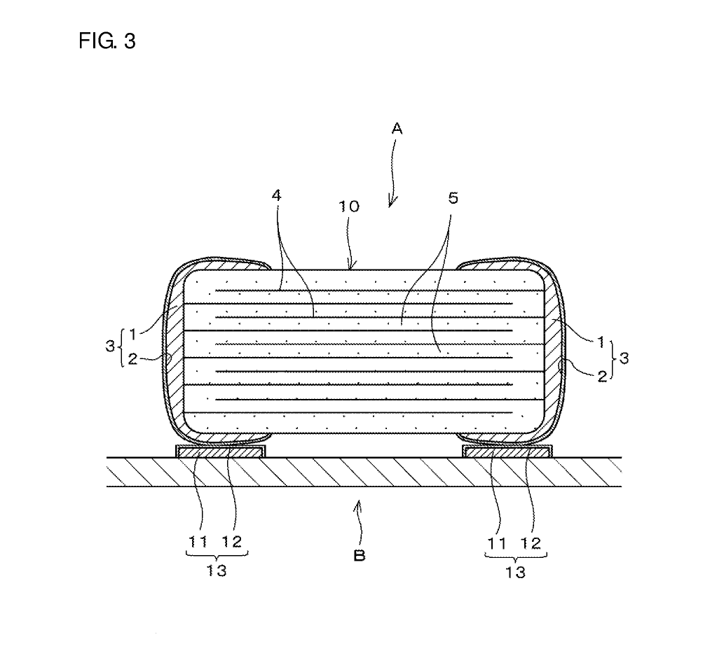

As shown in FIG. 3, chip type electronic parts A of sample Nos. 1 to 25 in Tables 1 and 2 were each placed on a glass-epoxy substrate B in such a manner that external electrodes (first joining objects) 3 are abutted against electrodes for mounting (second joining objects) 13 of the glass-epoxy substrates B of sample Nos. 1 to 25 in Tables 1 and 2, and the chip type electronic parts A were reflowed at 250° C. for 30 minutes.

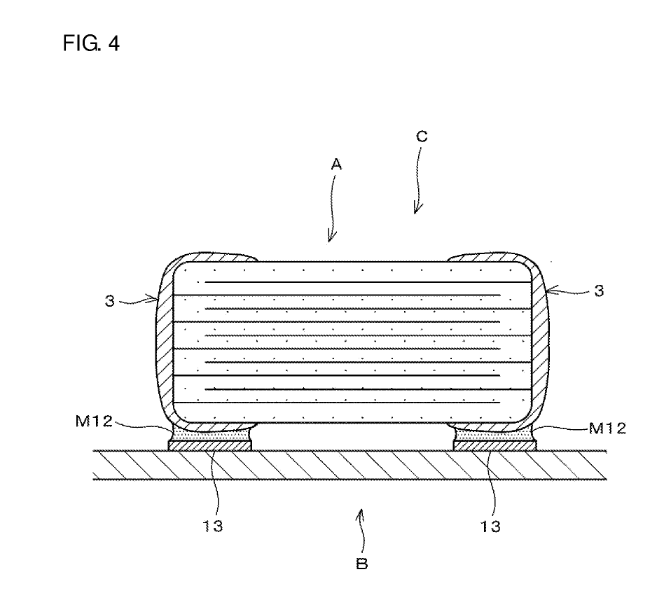

Thereby, as shown in FIG. 4, a joint structure C, in which the external electrode (first joining object) 3 of the chip type electronic part A and the electrode for mounting (second joining object) 13 of the glass-epoxy substrate B were joined to each other with an intermetallic compound (joint portion) M12 interposed therebetween, was obtained.

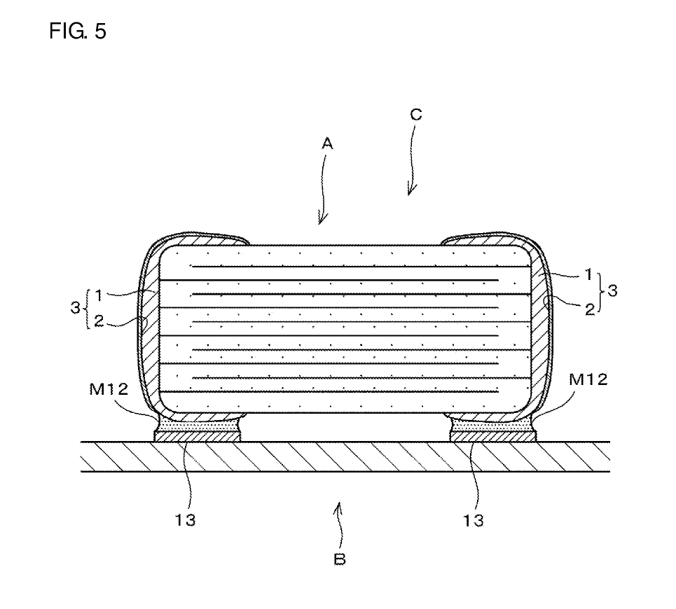

In addition, FIG. 5 shows a variation example of the joint structure C thus obtained. In the joint structure of the present invention, as shown in FIG. 5, in a portion which is not in contact with an opposite plating layer in a plating layer 2 constituting an external electrode 3 and composed of Sn or an alloy (low melting point metal) containing Sn, and a plating layer 12 constituting an electrode 13 for mounting and composed of Sn or an alloy (low melting point metal) containing Sn, the plating layer 2 and/or the plating layer 12 may remain unreacted.

Further, similarly, chip type electronic parts of sample Nos. 26 and 27, respectively complying with the requirements of the present invention, were placed on the second joining objects (a glass-epoxy substrate of the sample No. 26, which is provided with an external electrode having a plating layer made of Cu formed on the surface thereof, and a glass-epoxy substrate of the sample No. 27, which is provided with an external electrode having a plating layer made of a Cu—Zn alloy formed on the surface thereof) not complying with the requirements of the present invention in such a manner that the external electrode (first joining object) is abutted against the electrode for mounting (second joining object) on the glass-epoxy substrate B, and the chip type electronic parts were reflowed at 250° C. for 30 minutes to obtain joint structures.

[Evaluation of Characteristics]

The joint structures thus obtained were used as samples, and their characteristics were evaluated by the following methods.

<<Joint Strength>>

The shear strength of each of the obtained joint structures was measured by using a bonding tester, and the joint strength was evaluated.

Measurement of the shear strength was carried out under conditions of a lateral push rate: 0.1 mm·s⁻¹ and room temperature and 260° C.

The sample having a shear strength of 20 Nmm⁻² or more was rated as “⊙” (excellent), the sample having a shear strength of 2 Nmm⁻² or more and less than 20 Nmm⁻² was rated as “∘” (good), and the sample having a shear strength less than 2 Nmm⁻² was rated as “x” (defective).

The measured joint strength values at room temperature and at 260° C. of the samples and the evaluation results are shown together in Tables 1 and 2.

<<Evaluation of Remaining Component>>

About 7 mg of an intermetallic compound (reaction product), solidified after the reflow, in the joint portion was cut out, and subjected to differential scanning calorimetry (DSC) using Al₂O₃ as a reference under conditions of a measurement temperature of 30° C. to 300° C. and a temperature rise rate of 5° C./min in a nitrogen atmosphere. The amount of the remaining low melting point metal component was quantified from an endothermic quantity of a melting endothermic peak at a melting temperature of the low melting point metal (first metal) component in the resulting DSC chart and the content (% by volume) of the remaining low melting point metal was determined. Then, the case where the content of the remaining low melting point metal was 0% by volume was rated as “⊙” (excellent), the case where the content was more than 0% by volume and 50% by volume or less was rated as “∘” (good), and the case where the content was more than 50% by volume was rated as “x” (defective).

The contents of the remaining low melting point metal and evaluation results are shown together in Tables 1 and 2.

<<Flow Out Percent Defective>>

The flow out percent defective of the obtained joint structure was determined by the following method.

First, the joint structure was sealed with an epoxy resin, left standing in an environment of 85% in relative humidity, and heated in the reflow condition of a peak temperature of 260° C. The joint structure in which the joining material was remelted and flowed out was regarded as a defective one, and the incidence rate of flow out defects was determined. The flow out percent defective was determined from this result.

The case where the flow out percent defective of the joining material was 0% was rated as “⊙” (excellent), the case where it was more than 0% and 50% or less was rated as “∘” (good), and the case where it was more than 50% was rated as “x” (defective).

The flow out percent defectives and evaluation results are shown together in Tables 1 and 2.

<<Compactness>>

A cross-section of the obtained joint structure was observed with a metallograph and the presence or absence of air gaps present in a joint portion was checked. The case where no air gap more than 50 μm on a side was present was rated as “⊙” (excellent), and the case where an air gap more than 50 μm on a side was present was rated as “x” (defective).

The results of compactness evaluation are shown together in Tables 1 and 2.

TABLE 1

| | Composition of | Composition of | | | | | Content of | | | | |
|---|---|---|---|---|---|---|---|---|---|---|---|
| | Plating Layer | Plating Layer | Joint Strength and | | | | Remaining Low | | Flow Out Percent | | |
| | (First Metal) | (Second Metal) | Evaluation | | Joint Strength and | | Melting Point | | Defective and | | |
| | of First | of Second | (Room Temperature) | | Evaluation (260° C.) | | Metal and | | Evaluation | | |
| | Joining Object | Joining Object | Joint | | Joint | | Evaluation | | Percent | | |
| Sample | (Electronic | (Substrate | Strength | | Strength | | Content | | Defective | | Compact- |
| No. | Part Side) | Side) | (Nmm⁻²) | Evaluation | (Nmm⁻²) | Evaluation | (%) | Evaluation | (%) | Evaluation | ness |
| 1 | Sn—3Ag—0.5Cu | Cu—5Ni | 24 | ⊙ | 23 | ⊙ | 0 | ⊙ | 0 | ⊙ | ⊙ |
| 2 | Sn—3Ag—0.5Cu | Cu—10Ni | 23 | ⊙ | 22 | ⊙ | 0 | ⊙ | 0 | ⊙ | ⊙ |
| 3 | Sn—3Ag—0.5Cu | Cu—15Ni | 24 | ⊙ | 23 | ⊙ | 0 | ⊙ | 0 | ⊙ | ⊙ |
| 4 | Sn—3Ag—0.5Cu | Cu—20Ni | 25 | ⊙ | 24 | ⊙ | 0 | ⊙ | 0 | ⊙ | ⊙ |
| 5 | Sn—3Ag—0.5Cu | Cu—30Ni | 25 | ⊙ | 15 | ◯ | 15 | ◯ | 6 | ◯ | ⊙ |
| 6 | Sn—3Ag—0.5Cu | Cu—5Mn | 25 | ⊙ | 24 | ⊙ | 0 | ⊙ | 0 | ⊙ | ⊙ |
| 7 | Sn—3Ag—0.5Cu | Cu—10Mn | 24 | ⊙ | 24 | ⊙ | 0 | ⊙ | 0 | ⊙ | ⊙ |
| 8 | Sn—3Ag—0.5Cu | Cu—15Mn | 25 | ⊙ | 24 | ⊙ | 0 | ⊙ | 0 | ⊙ | ⊙ |
| 9 | Sn—3Ag—0.5Cu | Cu—20Mn | 26 | ⊙ | 25 | ⊙ | 0 | ⊙ | 0 | ⊙ | ⊙ |
| 10 | Sn—3Ag—0.5Cu | Cu—30Mn | 26 | ⊙ | 16 | ◯ | 15 | ◯ | 5 | ◯ | ⊙ |
| 11 | Sn | Cu—10Mn | 23 | ⊙ | 23 | ⊙ | 0 | ⊙ | 0 | ⊙ | ⊙ |
| 12 | Sn—3.5Ag | Cu—10Mn | 26 | ⊙ | 25 | ⊙ | 0 | ⊙ | 0 | ⊙ | ⊙ |
| 13 | Sn—0.75Cu | Cu—10Mn | 24 | ⊙ | 22 | ⊙ | 0 | ⊙ | 0 | ⊙ | ⊙ |
| 14 | Sn—15Bi | Cu—10Mn | 29 | ⊙ | 27 | ⊙ | 0 | ⊙ | 0 | ⊙ | ⊙ |

TABLE 2

| | | Composition | | | | | | | | | |
|---|---|---|---|---|---|---|---|---|---|---|---|
| | | of Plating | | | | | | | | | |
| | | Layer | | | | | | | | | |
| | Composition of | (Second | | | | | Content of | | | | |
| | Plating Layer | Metal) of | Joint Strength and | | Joint Strength | | Remaining Low | | Flow Out Percent | | |
| | (First Metal) of | Second | Evaluation (Room | | and Evaluation | | Melting Point | | Defective and | | |
| | First Joining | Joining | Temperature) | | (260° C.) | | Metal and | | Evaluation | | |
| | Object | Object | Joint | | Joint | | Evaluation | | Percent | | |
| Sample | (Electronic | (Substrate | Strength | Eval- | Strength | Eval- | Content | Eval- | Defective | Eval- | Compact- |
| No. | Part Side) | Side) | (Nmm⁻²) | uation | (Nmm⁻²) | uation | (%) | uation | (%) | uation | ness |
| 15 | Sn—0.7Cu—0.05Ni | Cu—10Mn | 25 | ⊙ | 24 | ⊙ | 0 | ⊙ | 0 | ⊙ | ⊙ |
| 16 | Sn—5Sb | Cu—10Mn | 25 | ⊙ | 21 | ⊙ | 0 | ⊙ | 0 | ⊙ | ⊙ |
| 17 | Sn—2Ag—0.5Cu—2Bi | Cu—10Mn | 28 | ⊙ | 25 | ⊙ | 0 | ⊙ | 0 | ⊙ | ⊙ |
| 18 | Sn—30Bi | Cu—10Mn | 29 | ⊙ | 27 | ⊙ | 15 | ◯ | 11 | ◯ | ⊙ |
| 19 | Sn—3.5Ag—0.5Bi—8In | Cu—10Mn | 27 | ⊙ | 24 | ⊙ | 0 | ⊙ | 0 | ⊙ | ⊙ |
| 20 | Sn—9Zn | Cu—10Mn | 24 | ⊙ | 24 | ⊙ | 0 | ⊙ | 0 | ⊙ | ⊙ |
| 21 | Sn—8Zn—3Bi | Cu—10Mn | 23 | ⊙ | 22 | ⊙ | 0 | ⊙ | 0 | ⊙ | ⊙ |
| 22 | Sn—3Ag—0.5Cu | Cu—12Mn—4Ni | 25 | ⊙ | 21 | ⊙ | 0 | ⊙ | 0 | ⊙ | ⊙ |
| 23 | Sn—3Ag—0.5Cu | Cu—10Mn—1P | 26 | ⊙ | 22 | ⊙ | 0 | ⊙ | 0 | ⊙ | ⊙ |
| 24 | Sn—3Ag—0.5Cu | Cu—10Al | 24 | ⊙ | 22 | ⊙ | 21 | ◯ | 14 | ◯ | ⊙ |
| 25 | Sn—3Ag—0.5Cu | Cu—10Cr | 25 | ⊙ | 24 | ⊙ | 39 | ◯ | 24 | ◯ | ⊙ |
| *26 | Sn—3Ag—0.5Cu | Cu | 27 | ⊙ | 0.7 | X | 79 | X | 61 | X | ⊙ |
| *27 | Sn—3Ag—0.5Cu | Cu—10Zn | 26 | ⊙ | 0.9 | X | 73 | X | 64 | X | ⊙ |

A sample with the sample No. marked with * is a sample not satisfying the requirements of the present invention. (comparative example)

As shown in Tables 1 and 2, it was verified with respect to the joint strength at room temperature that both of the samples (examples) of sample Nos. 1 to 25 complying with the requirements of the present invention and the samples of comparative example of sample Nos. 26 and 27 not complying with the requirements of the present invention exhibit a joint strength of 20 Nmm⁻² or more and have practical strength.

On the other hand, with respect to the joint strength at 260° C., it was verified that while the samples of comparative examples of sample Nos. 26 and 27 exhibited an insufficient joint strength of 2 Nmm⁻² or less, the samples of examples of the present invention of sample Nos. 1 to 25 held a joint strength of 20 Nmm⁻² or more and have practical strength.

Further, it was verified with respect to the content of the remaining low melting point metal (evaluation of a remaining component) that while the samples of comparative examples of sample Nos. 26 and 27 have contents of the remaining low melting point metal of more than 50% by volume, all of the samples of examples of the present invention of sample Nos. 1 to 25 have contents of the remaining low melting point metal of 50% by volume or less.

Further, it was verified that the samples of sample Nos. 1 to 23 using the Cu—Ni alloy, the Cu—Mn alloy, the Cu—Mn—Ni alloy or the Cu—Mn—P alloy as the second metal have lower contents of the remaining low melting point metal than the samples of sample Nos. 24 and 25 using the Cu—Al alloy or the Cu—Cr alloy as the second metal.

Further, it was verified that the samples of sample Nos. 1 to 4 and 6 to 9 using the Cu—Ni alloy or the Cu—Mn alloy in which the amount of Ni or Mn is 5 to 20% by weight have lower contents of the remaining low melting point metal than the samples of sample Nos. 5 and 10 in which the amount of Ni or Mn is 30% by weight.

Moreover, it was verified that the samples of sample Nos. 1 to 4, 6 to 9, 11 to 17 and 19 to 23 using Sn or an alloy containing Sn in an amount of 85% by weight or more as the low melting point metal are particularly preferred since the content of the remaining low melting point metal thereof is 0% by volume.

Further, with respect to the flow out percent defective of the joining material, it was verified that in the samples of comparative examples of sample Nos. 26 and 27, the flow out percent defective was 50% or more, and on the other hand, in all of the samples of examples of the present invention of sample Nos. 1 to 25, the flow out percent defective was 50% or less, and particularly the samples of examples of sample Nos. 1 to 4, 6 to 9, 11 to 17 and 19 to 23, in which Sn or an alloy containing Sn in an amount of 85% by weight or more is used as the low melting point metal, have high heat resistance so that the flow out percent defective was 0%.

Further, as described above, it was verified that all of the samples of sample Nos. 1 to 25 complying with the requirements of the present invention have practical heat resistance irrespective of the type of the first metal (low melting point metal), but it was found that in the samples of sample Nos. 5 and 10 in which the amount of Ni or Mn in the second metal is 30% by weight, the joint strength at 260° C. tends to be slightly lower compared with other samples (sample Nos. 1 to 4, 6 to 9, and 11 to 25).

In addition, it was verified that in accordance with the joining method of the present invention, a highly compact joint portion is obtained compared with the case where a first joining object and a second joining object, respectively containing no first metal such as Sn, are joined to each other by using a solder paste containing a first metal powder such as Sn, a second metal powder (Cu—Mn alloy or Cu—Ni alloy) having a higher melting point than the first metal powder, and a flux component, as described in the above-mentioned joining method of Patent Document 2.

### Embodiment 2

In Embodiment 1 described above, a case in which a chip type electronic part provided with an external electrode (first joining object) having a plating layer of the first metal (Sn or an alloy containing Sn) and a glass-epoxy substrate provided with an electrode for mounting (second joining object) having a plating layer of the second metal (Cu alloy) are used and the external electrode of the chip type electronic part is joined to the electrode for mounting of the glass-epoxy substrate has been described as an example. In the present Embodiment 2, a glass-epoxy substrate provided with an electrode for mounting (first joining object) having a plating layer of the first metal (Sn or an alloy containing Sn) and a chip type electronic part provided with an external electrode (second joining object) having a plating layer of the second metal (Cu alloy) were used and the electrode for mounting (first joining object) of the glass-epoxy substrate was joined to the external electrode (second joining object) of the chip type electronic part.

That is, in Embodiment 2, samples in which the type of the metal composing a plating layer of an external electrode of a chip type electronic part and the type of the metal composing a plating layer of an electrode for mounting of a glass-epoxy substrate are reversed to the types of metals in Embodiment 1, that is, glass-epoxy substrates provided with electrodes for mounting (first joining objects) of sample Nos. 101 to 125 in Tables 3 and 4, and chip type electronic parts provided with external electrodes (second joining objects) of sample Nos. 101 to 125 were prepared, and comparative samples (comparative examples) of sample Nos. 126 and 127 were prepared, and the glass-epoxy substrate and the chip type electronic part were joined to each other by the same method and in the same condition as in Embodiment 1.

Then, the resulting joint structures were used as samples, and characteristics of each sample were evaluated in the same manner as in Embodiment 1. The results of evaluation are shown in Tables 3 and 4.

TABLE 3

| | | Composition | | | | | | | | | |
|---|---|---|---|---|---|---|---|---|---|---|---|
| | | of Plating | | | | | | | | | |
| | | Layer | | | | | | | | | |
| | | (Second | | | | | Content of | | | | |
| | Composition of | Metal) of | Joint Strength and | | | | Remaining Low | | Flow Out Percent | | |
| | Plating Layer | Second | Evaluation (Room | | Joint Strength and | | Melting Point | | Defective and | | |
| | (First Metal) of | Joining | Temperature) | | Evaluation (260° C.) | | Metal and | | Evaluation | | |
| | First Joining | Object | Joint | | Joint | | Evaluation | | Percent | | |
| Sample | Object | (Electronic | Strength | | Strength | | Content | | Defective | | |
| No. | (Substrate Side) | Part Side) | (Nmm⁻²) | Evaluation | (Nmm⁻²) | Evaluation | (%) | Evaluation | (%) | Evaluation | Compactness |
| 101 | Sn—3Ag—0.5Cu | Cu—5Ni | 25 | ⊙ | 24 | ⊙ | 0 | ⊙ | 0 | ⊙ | ⊙ |
| 102 | Sn—3Ag—0.5Cu | Cu—10Ni | 24 | ⊙ | 22 | ⊙ | 0 | ⊙ | 0 | ⊙ | ⊙ |
| 103 | Sn—3Ag—0.5Cu | Cu—15Ni | 25 | ⊙ | 24 | ⊙ | 0 | ⊙ | 0 | ⊙ | ⊙ |
| 104 | Sn—3Ag—0.5Cu | Cu—20Ni | 26 | ⊙ | 24 | ⊙ | 0 | ⊙ | 0 | ⊙ | ⊙ |
| 105 | Sn—3Ag—0.5Cu | Cu—30Ni | 26 | ⊙ | 13 | ◯ | 17 | ◯ | 9 | ◯ | ⊙ |
| 106 | Sn—3Ag—0.5Cu | Cu—5Mn | 25 | ⊙ | 25 | ⊙ | 0 | ⊙ | 0 | ⊙ | ⊙ |
| 107 | Sn—3Ag—0.5Cu | Cu—10Mn | 24 | ⊙ | 23 | ⊙ | 0 | ⊙ | 0 | ⊙ | ⊙ |
| 108 | Sn—3Ag—0.5Cu | Cu—15Mn | 26 | ⊙ | 24 | ⊙ | 0 | ⊙ | 0 | ⊙ | ⊙ |
| 109 | Sn—3Ag—0.5Cu | Cu—20Mn | 26 | ⊙ | 25 | ⊙ | 0 | ⊙ | 0 | ⊙ | ⊙ |
| 110 | Sn—3Ag—0.5Cu | Cu—30Mn | 26 | ⊙ | 13 | ◯ | 18 | ◯ | 8 | ◯ | ⊙ |
| 111 | Sn | Cu—10Mn | 22 | ⊙ | 22 | ⊙ | 0 | ⊙ | 0 | ⊙ | ⊙ |
| 112 | Sn—3.5Ag | Cu—10Mn | 25 | ⊙ | 24 | ⊙ | 0 | ⊙ | 0 | ⊙ | ⊙ |
| 113 | Sn—0.75Cu | Cu—10Mn | 24 | ⊙ | 23 | ⊙ | 0 | ⊙ | 0 | ⊙ | ⊙ |
| 114 | Sn—15Bi | Cu—10Mn | 29 | ⊙ | 27 | ⊙ | 0 | ⊙ | 0 | ⊙ | ⊙ |

TABLE 4

| | | Composition | | | | | | | | | |
|---|---|---|---|---|---|---|---|---|---|---|---|
| | | of Plating | | | | | | | | | |
| | | Layer | | | | | | | | | |
| | | (Second | | | | | Content of | | | | |
| | Composition of | Metal) of | Joint Strength and | | Joint Strength | | Remaining Low | | Flow Out Percent | | |
| | Plating Layer | Second | Evaluation (Room | | and Evaluation | | Melting Point | | Defective and | | |
| | (First Metal) of | Joining | Temperature) | | (260° C.) | | Metal and | | Evaluation | | |
| | First Joining | Object | Joint | | Joint | | Evaluation | | Percent | | |
| Sample | Object | (Electronic | Strength | Eval- | Strength | Eval- | Content | Eval- | Defective | Eval- | Compact- |
| No. | (Substrate Side) | Part Side) | (Nmm⁻²) | uation | (Nmm⁻²) | uation | (%) | uation | (%) | uation | ness |
| 115 | Sn—0.7Cu—0.05Ni | Cu—10Mn | 26 | ⊙ | 25 | ⊙ | 0 | ⊙ | 0 | ⊙ | ⊙ |
| 116 | Sn—5Sb | Cu—10Mn | 25 | ⊙ | 24 | ⊙ | 0 | ⊙ | 0 | ⊙ | ⊙ |
| 117 | Sn—2Ag—0.5Cu—2Bi | Cu—10Mn | 26 | ⊙ | 25 | ⊙ | 0 | ⊙ | 0 | ⊙ | ⊙ |
| 118 | Sn—30Bi | Cu—10Mn | 27 | ⊙ | 27 | ⊙ | 14 | ◯ | 13 | ◯ | ⊙ |
| 119 | Sn—3.5Ag—0.5Bi—8In | Cu—10Mn | 25 | ⊙ | 24 | ⊙ | 0 | ⊙ | 0 | ⊙ | ⊙ |
| 120 | Sn—9Zn | Cu—10Mn | 24 | ⊙ | 23 | ⊙ | 0 | ⊙ | 0 | ⊙ | ⊙ |
| 121 | Sn—8Zn—3Bi | Cu—10Mn | 23 | ⊙ | 23 | ⊙ | 0 | ⊙ | 0 | ⊙ | ⊙ |
| 122 | Sn—3Ag—0.5Cu | Cu—12Mn—4Ni | 25 | ⊙ | 22 | ⊙ | 0 | ⊙ | ⊙ | ⊙ | ⊙ |
| 123 | Sn—3Ag—0.5Cu | Cu—10Mn—1P | 24 | ⊙ | 22 | ⊙ | 0 | ⊙ | 0 | ⊙ | ⊙ |
| 124 | Sn—3Ag—0.5Cu | Cu—10Al | 23 | ⊙ | 22 | ⊙ | 22 | ◯ | 17 | ◯ | ⊙ |
| 125 | Sn—3Ag—0.5Cu | Cu—10Cr | 25 | ⊙ | 25 | ⊙ | 38 | ◯ | 24 | ◯ | ⊙ |
| *126 | Sn—3Ag—0.5Cu | Cu | 26 | ⊙ | 0.9 | X | 79 | X | 66 | X | ⊙ |
| *127 | Sn—3Ag—0.5Cu | Cu—10Zn | 25 | ⊙ | 1.1 | X | 74 | X | 65 | X | ⊙ |

A sample with the sample No. marked with * is a sample not satisfying the requirements of the present invention. (comparative example)

As shown in Tables 3 and 4, evaluation results of the characteristics similar to the case of Embodiment 1 were obtained also in the case of Embodiment 2.

In addition, since evaluation results of the characteristics are similar to the case of Embodiment 1 and their tendencies are the same as in the case of Embodiment 1, in order to avoid duplication, only data of the evaluation results are shown in Tables 3 and 4 and explanations of the evaluation results are omitted.

It was verified from the results of Embodiments 1 and 2 that the first joining object and the second joining object can be efficiently joined to each other without having to use a joining material such as a solder paste to perform highly reliable joining in which there is no air gap in the joint portion and the joint portion is excellent in heat resistance when one of the electrode on a substrate side and the electrode on a chip type electronic part side has the first metal of the present invention and the other has the second metal of the present invention, that is, when the first joining object and the second joining object comply with the requirements of the present invention.

### Embodiment 3

In the present embodiment 3, a case in which a bump, as a first joining object, disposed on an electrode of a bottom face of an IC chip is joined to an electrode for mounting, as a second joining object, of a substrate will be described.

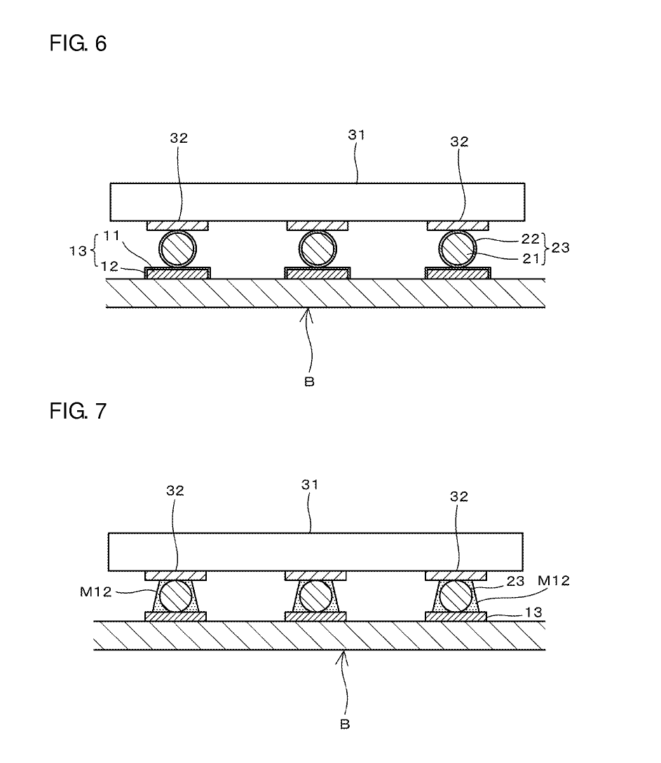

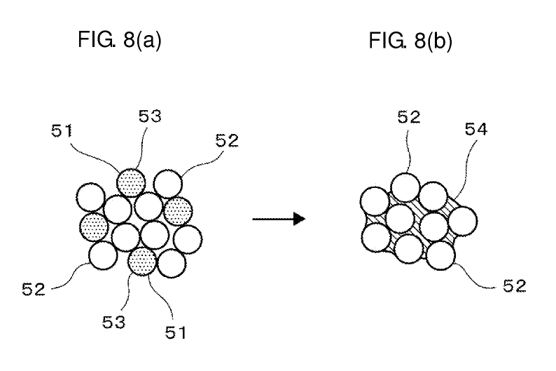

First, an IC chip 31 as shown in FIG. 6 was prepared. The IC chip 31 has a bump (first joining object) 23 which is disposed on an electrode 32 of a bottom face of the IC chip, and has a plating layer 22 made of Sn or an alloy (first metal) containing Sn formed on the surface of a bump core 21.

As the first metal, for example, metals as shown in sample Nos. 1 to 25 in Tables 1 and 2 can be used.

As a material of the bump core 21, a material, such as Au, on the surface of which a plating layer 22 can be formed by the first metal, is used.

The plating layer 22 does not necessarily have to cover the entire surface of the bump core 21, and the plating layer 2 may be provided for the bump core 21 in such a manner that an intermetallic compound is formed by the reaction with a second metal (a Cu alloy is employed in this embodiment) composing a plating film 12 an electrode 13 for mounting described below in a heat treatment step.

Further, as shown in FIG. 6, prepared was a glass-epoxy substrate B having an electrode for mounting (second joining object) 13 provided with a plating layer 12 which was formed by plating the surface of a Cu electrode film 11 formed on the principal surface of a substrate made of glass-epoxy with an alloy (second metal) containing at least one selected from among Ni, Mn, Al and Cr, and Cu.

As the second metal, for example, metals as shown in sample Nos. 1 to 25 in Tables 1 and 2 can be used. In addition, the plating layer 12 may be formed so as to cover the entire surface of the Cu electrode film 11, that is, the top face and the side face of the Cu electrode film 11, as shown in FIG. 6, or may be formed only on the top face of the Cu electrode film 11 or only on a part of the top face, although not shown.

Next, the IC chip 31 was placed on the glass-epoxy substrate B in such a manner that the plating layer 22 of the bump 23 as a first joining object is abutted against the electrode for mounting (second joining object) 13 of the glass-epoxy substrate B, and the IC chip 31 was heated and pressed simultaneously. In addition, heating and pressing were performed by a method by which a plurality of IC chips 31 can be simultaneously heated and pressed, and the heating condition was set to 200° C. or higher and the pressing condition was set based on the pressed area.

Almost all of Sn or an alloy (first metal) containing Sn produces an intermetallic compound M12 by the reaction of the first metal with the second metal after this heating and pressing.

Then, as shown in FIG. 7, a joint structure in which the plating layer 22 of the bump 23 (first joining object) and the electrode 13 for mounting (second joining object) of the glass-epoxy substrate B were joined to each other with the intermetallic compound (joint portion) M12 interposed therebetween was obtained. In this state, since joining is performed only with the intermetallic compound, underfill may be further applied between the IC chip 31 and the glass-epoxy substrate B in order to secure the joint strength.

In addition, the bump core 21 may be plated with a second metal, and a plating film composed of a first metal may be disposed on a substrate side. In this case, as a material of the bump core 21, a material, such as Au, on the surface of which a plating layer can be formed by the second metal, is used.

In addition, when the second metal is used for the bump core 21, the plating layer 22 does not have to be disposed.

The joining method of Embodiment 3 and the joint structure obtained by the joining method also achieve the same effect as those of Embodiments 1 and 2.

In addition, in the Embodiments 1 and 2, a case in which the first joining object is an external electrode of a chip type electronic part (laminated ceramic capacitor) in Embodiments 1 and 2 described above, or is a bump provided on an IC chip in Embodiment 3, and the second joining object is an electrode for mounting of a glass-epoxy substrate in any of Embodiments 1 to 3 has been described as an example, but types of the first joining object and the second joining object are not limited to these cases. For example, the first joining object and the second joining object may be an external electrode or a bump of an electronic part having another constitution, or an electrode formed on another substrate.

The present invention is not intended to be limited to the above-mentioned embodiments in other points, and various applications and variations may be made on the composition of the first metal and the second metal within the scope of the invention.

### DESCRIPTION OF REFERENCE SYMBOLS

1 External electrode main body
2 Plating layer of first metal (low melting point metal) constituting external electrode
3 External electrode (first joining object) Ceramic laminate
11 Cu electrode film
12 Plating layer of second metal constituting electrode for mounting
13 Electrode for mounting (second joining object)
21 Bump core
22 Plating layer of first metal on the surface of bump core
23 Bump (first joining object)
31 IC chip
32 Electrode of IC chip
A Chip type electronic part
B Glass-epoxy substrate
C Joint structure
M12 Intermetallic compound

1. A method of joining objects to each other, the method comprising:
contacting a first joining object having a first metal composed of Sn or an alloy containing Sn to a second joining object having a second metal composed of an alloy containing at least one selected from among Ni, Mn, Al and Cr, and Cu; and
subjecting the first joining object and the second joining object to a heat treatment while in contact with each other until an intermetallic compound is produced at an interface between both the first and the second joining objects such that the first joining object and the second joining object are joined to each other.

2. The joining method according to claim 1, wherein the first metal is an alloy containing Sn in an amount of 70% by weight or more.

3. The joining method according to claim 1, wherein the first metal is an alloy containing Sn in an amount of 85% by weight or more.

4. The joining method according to claim 1, wherein the second metal is predominantly composed of a Cu—Ni alloy.

5. The joining method according to claim 4, wherein the Cu—Ni alloy contains Ni in an amount of 5 to 30% by weight.

6. The joining method according to claim 1, wherein the second metal is predominantly composed of a Cu—Mn alloy.

7. The joining method according to claim 6, wherein the Cu—Mn alloy contains Mn in an amount of 5 to 30% by weight.

8. The joining method according to claim 6, wherein the heat treatment is 250° C. for 30 minutes.

9. A joint structure formed by the joining method according to claim 1.

10. A method for producing a joint structure, wherein the joining method according to claim 1 is used.
